(19) United States
(12) Patent Application Publication
(10) Pub. No.: US 2006/0033239 A1
(43) Pub. Date: Feb. 16, 2006

(54) Preliminary forming apparatus, preliminary forming method and main forming method that uses the apparatus, and film picture

(76) Inventor: Kunio Imai, Ishikawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/540,131

(22) PCT Filed: Aug. 4, 2003
(86) PCT No.: PCT/JP03/09853

§ 371 Date: Jun. 20, 2005

(30) Foreign Application Priority Data
Dec. 20, 2002 (JP) 2002369526
Feb. 21, 2003 (JP) 200343846

(51) Int. Cl. B29C 43/02

(52) U.S. Cl. 264/322; 425/387.1

(57) ABSTRACT

An object of the present invention is to provide a pre-formation apparatus capable of making a pre-formation with highly dimensional accuracy between a film three-dimensional shape and an original design on a film, a pre-formation method and a main formation method utilizing the apparatus, and a printed film therefor.

The pre-formation apparatus includes: an upper and a lower clamp members 68j which have a through hole 68a and sandwich a printed film, and a heater 70 movable to and away from a pre-forming section F for heating the printed film. A pre-forming mold 80 which pre-forms the printed film 4 via the through hole 68a, and a film die punch for punching after the pre-formation are movable to and away from the pre-forming section F. The pre-forming mold 80 includes a male mold which contacts the plasticized printed film and a female mold which mates with the male mold for a formation under vacuum. The apparatus further includes a pitch detecting section facing the pre-forming section F within a pitch of the printed film 4 in a film flow direction X for detection of a film mark M1.

### TECHNICAL FIELD

The present invention relates to pre-formation apparatuses which perform a pre-forming operation to printed film for insert molding, in-mold formation, etc. More specifically, the present invention relates to a pre-formation apparatus including: a film feeder which supplies a printed film to a pre-forming section where a pre-formation is preformed; upper and lower clamp members which have through holes and clamp the printed film in the pre-forming section; a heater which is movable toward and away from the pre-forming section for heating to plasticize the printed film held by the upper and lower clamp members in the pre-forming section before the pre-formation; a pre-forming mold which is movable toward and away from the pre-forming section for pre-forming the printed film through the through hole; and a film die punch for punching the printed film after the pre-formation. The present invention further relates to a pre-formation method and a main formation method utilizing the pre-formation apparatus, and also to a printed film

### BACKGROUND ART

JP-A 2000-52416 for example discloses a conventional method of forming a film for insert molding. According to the technique disclosed therein, an insert film is sandwiched between a pre-formation mold and a clamp, a vacuum forming is performed while the film is heated by a heater, and then the film is demolded by means of heat from an electric heater incorporated in the mold. However, since the film is only vacuumed onto the female mold, the film deforms unevenly, making it difficult to maintain dimensional accuracy of the molded product.

To this problem, the inventor proposed a method, as disclosed in International Patent Application WO 02/078973, in which the film is held between clamp members and pre-heated, and then the softened film is pressed up by a male mold onto a female mold. In this method, uneven deformation was reduced in a region of the film which was pressed up against the female mold. However, due to a location of a film flow pitch detecting device, which was placed farther away from the pre-forming section than from the film supply side, there has been a limit in improving dimensional accuracy between the design produced on the molded product and the design printed on the film.

As a reference, a mention will be made here for JP-A 1-237110. FIG. 2 of the gazette discloses that a longitudinal sensor 92 of a movable type is provided. On the contrary, description on page 3 of the gazette states that a longitudinal sensor 92′ may not be movable, and no reference is made for errors arising from positional relationship between the movable and non-movable types. Essentially, the technique relates to in-mold formation which does not involve film preheating. As shown in FIG. 1 of the gazette, the film is not provided with any support by means of fixation by a clamp for example, and under this condition the film is then contacted by a male mold 15. This causes more fundamental problems than dimensional accuracy which is an object of the present invention, and therefore this prior art discloses nothing about the objects of the present invention nor about constitution thereof.

Under the circumstances described above, it is an object of the present invention to provide a pre-formation apparatus capable of making a film pre-formation for a highly accurate three-dimensional design produced on a molded product with respect to an original design on the film. Another object of the present invention is to provide a pre-formation method and a main formation method utilizing the apparatus, and a printed film therefor.

### DISCLOSURE OF THE INVENTION

In order to achieve the objects, a pre-formation apparatus according to the present invention, includes a film feeder for supplying a printed film to a pre-forming section where a pre-formation is performed; an upper and a lower clamp members for sandwiching the printed film in the pre-forming section, and having a through hole; a heater movable to and away from the pre-forming section for heating to plasticize the printed film sandwiched by the upper and lower clamp members in the pre-forming section before the pre-formation; pre-forming molds movable to and away from the pre-forming section for pre-forming the printed film via the through hole; and a film die punch for punching the printed film after the pre-formation. The pre-forming molds include a male mold for contacting the plasticized printed film and a female mold to mate with the male mold for a vacuum formation. The pre-formation apparatus further includes a pitch detecting section facing the pre-forming section, within a pitch of the printed film in a film flow direction for detection of a film mark.

According to the characteristics described above, the pitch detecting section which detects a film mark is disposed to face the pre-forming section, within a pitch in a film flow direction of the printed film. Thus, even if there is some film elongation, positional error of a design with respect to the mold is reduced. When the printed film is sandwiched by the upper and lower clamp members under this state, horizontal position of the film with respect to the mold is fixed. Then, as the male mold is pressed against the plasticized printed film, the male mold makes contact with the most appropriate position of the design, and then a formation process is performed. Therefore, deformation and dislocation of the design caused by the contact of the male mold is dramatically reduced as compared with the conventional method. In this situation, the female mold accepts the male mold and formation is performed under a vacuum. Therefore, dimensional accuracy between the design and the mold is extremely high.

In particular, the pitch detecting section is preferably disposed at a center of the width of pitch. This arrangement enables to minimize the positional error due to printed film elongation, etc.

Preferably, the pitch detecting section has at least its vertical position fixed with respect to a pair of rollers which support the printed film in the pre-forming section. Since the film is supported by a pair of rollers, the error is reduced simply by fixing the relative position to the rollers

Further, it is preferable that the lower clamp member has at least its vertical position fixed with respect to the pair of rollers which support the printed film in the pre-forming section and the pitch detecting section is virtually fixed to the lower clamp member. In consideration that the film will drape down by its weight and in consideration of reducing the number of movable parts, error reduction can be accomplished by fixing the lower side. In this case, preferably, the upper clamp member is formed with a slit for housing the pitch detecting section.

Preferably the pre-formation apparatus further includes: meandering detection sections disposed between the pre-forming section and the pair of rollers which support the printed film for detecting a meandering prevention line printed on the printed film; and a meandering prevention device controlled by this second detection section as part of the film feeder. These enable to further reduce positional error widthwise of the printed film. Particularly in the present invention, after the formed portion is punched, the film is rarely left with bulges, which helps the meandering prevention device work effectively and thereby improve widthwise dimensional accuracy dramatically over conventional in-mold formation.

Preferably, the upper and lower clamp members generally cover a region of the printed film exposed to the meandering detection sections along a film flowing direction. Further, preferably, wherein the heater does not face the region of the printed film exposed to the meandering detection sections along a film flowing direction. These arrangements enable to reduce heat deformation of the region which includes the meandering prevention line, making accurate widthwise control for a short film pitch. Still preferably, the meandering detection section is provided on two sides of the printed film with respect to a film widthwise direction.

On the other hand, a pre-formation method which uses the pre-formation apparatus according to the present invention includes: a step of causing the film feeder to supply the printed film to the pre-forming section where a pre-formation is performed; a step of stopping the film supply through detection of the film mark by the pitch detecting section within the pitch in the film flowing direction of the printed film; a step of causing the upper and a lower clamp members to sandwich a margin around a formation region of the printed film; a step of moving a heater close to the pre-forming section and heating to plasticize the printed film; a step of performing the pre-formation using the pre-forming molds; and a step of punching the pre-formed film for making a formation film for insertion into the main mold.

A main formation method which uses the pre-formation apparatus according to the present invention includes: a step of causing the film feeder for supplying a printed film to a pre-forming section for a pre-formation; a step of stopping the film supply through detection of the film mark by the pitch detecting section within the pitch in a film flowing direction of the printed film; a step of causing the upper and a lower clamp members to sandwich a margin around a formation region of the printed film; a step of moving a heater close to the pre-forming section and heating to plasticize the printed film; a step of performing a pre-formation using the pre-forming molds; a step of punching the pre-formed film for making a formation film for insertion into the main mold; and a step of supplying resin to the main mold after inserting the formation film.

A printed film which is used in the pre-formation apparatus according to the present invention is provided with a film mark at a center of a pitch in a film flow direction, and a meandering prevention line.

As described, these characteristics of the pre-formation apparatus according to the present invention, of the pre-formation method and of the main formation method enable dramatic improvement on dimensional accuracy between a design on the film and a three-dimensional shape of the formed film. Further, since the film is only sandwiched by the upper and lower clamp members after its position is adjusted in its flow-wise and widthwise directions, the apparatus is highly durable and easy to maintain, enabling superb pre-formation without wasting the printed film very much.

Other objects, constitutions and advantages of the present invention will become clearer from the following “Mode of Embodying the Invention” to be made hereinafter.

### BRIEF DESCRIPTION OF THE DRAWINGS

FIG. 1 is a schematic diagram of a pre-formation apparatus.

FIG. 2 is a plan view showing a relationship between the pre-formation apparatus, a formed-film conveyer and a main formation apparatus.

FIG. 3(a) is a perspective view of a molded product with a design provided inside thereof; FIG. 3(b) is a perspective view of a molded product with a design provided outside thereof.

FIG. 4 is an enlarged sectional view of a molded product molded with a printed film.

FIG. 5 is a plan view of a primary portion including a pre-forming section according to the present invention.

FIG. 6 is a front view of a primary portion in FIG. 5.

FIG. 7 is an enlarged view of a region including a flow pitch detecting device.

FIG. 8 is a sectional view taken in lines A-A in FIG. 7.

FIG. 9 is a perspective view showing a film being conveyed.

FIGS. 10(a) and (c) show a relationship between film match marks and the flow pitch detecting device; FIGS. 10(b), (d) and (e) are film plan views; FIGS. 10(a), (b) and (e) are diagrams depicting the present invention; and FIGS. 10(c) and (d) illustrate comparative examples.

FIG. 11 is a front view of the pre-formation apparatus according to the present invention.

FIG. 12 is a front view of the pre-formation apparatus with its upper and lower actuators extended from the state in FIG. 11.

FIG. 13 is a front view of the pre-formation apparatus with its second rod of the lower actuator extended from the state in FIG. 12.

FIG. 14(a) is a side view of an upper half of the system in the state depicted in FIG. 11; FIG. 14(b) is a side view of the upper half of the system in the state depicted in FIG. 12.

FIG. 15 is a front view of a primary portion, showing a procedure of a pre-formation according to the present invention.

FIG. 16 is another front view of the primary portion following the step in FIG. 15, showing a heater now moved to an upper mold.

FIG. 17 is another front view of the primary portion following the step in FIG. 16, showing the upper mold now lowered.

FIG. 18 is another front view of the primary portion following the step in FIG. 17, showing the upper mold now raised.

FIG. 19 is another front view of the primary portion following the step in FIG. 18, showing a situation after punching

FIG. 20 shows a second embodiment of the present invention, and the view corresponding to FIG. 15.

### BEST MODE FOR CARRYING OUT THE INVENTION

Next, the present invention will be described in further detail, with reference to the attached drawings.

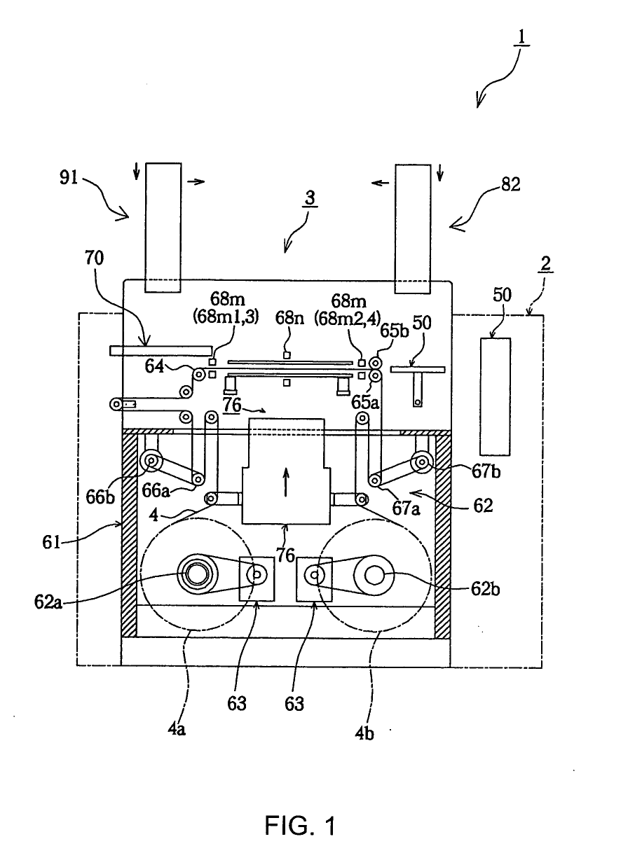

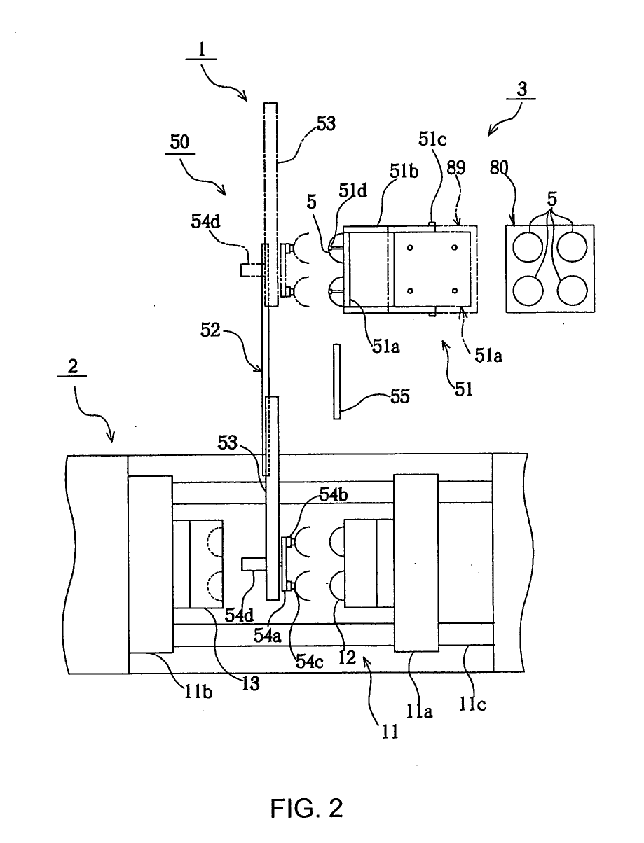

As shown in FIGS. 1 and 2, a formation system 1 according to the present invention includes a main formation apparatus 2 and a pre-formation apparatus 3. The pre-formation apparatus 3 performs a forming process and a punching process to a printed film 4 which is unwound from a roll, and thereby prepares a formation film 5 which is then utilized in the main formation apparatus 2.

The main formation apparatus 2 shown in FIG. 2 includes a mold clamping unit 11 and an unillustrated injection unit. The mold clamping unit 11 includes a movable plate 11a which is slidable via four rods 11c, and a fixed plate 11b faced thereto. A main mold set provided by a movable mold 12 and a fixed mold 13 are attached to the movable plate 11a and fixed plate 11b respectively. A gap between the movable mold 12 and the fixed mold 13 serves as an injection molding space for a main formation. The movable mold 12 and the fixed mold 13 are fitted and unfitted by an actuator and the movable plate 11a. The actuator has a hole through which the injection unit supplies a thermally plasticized resin to the injection space.

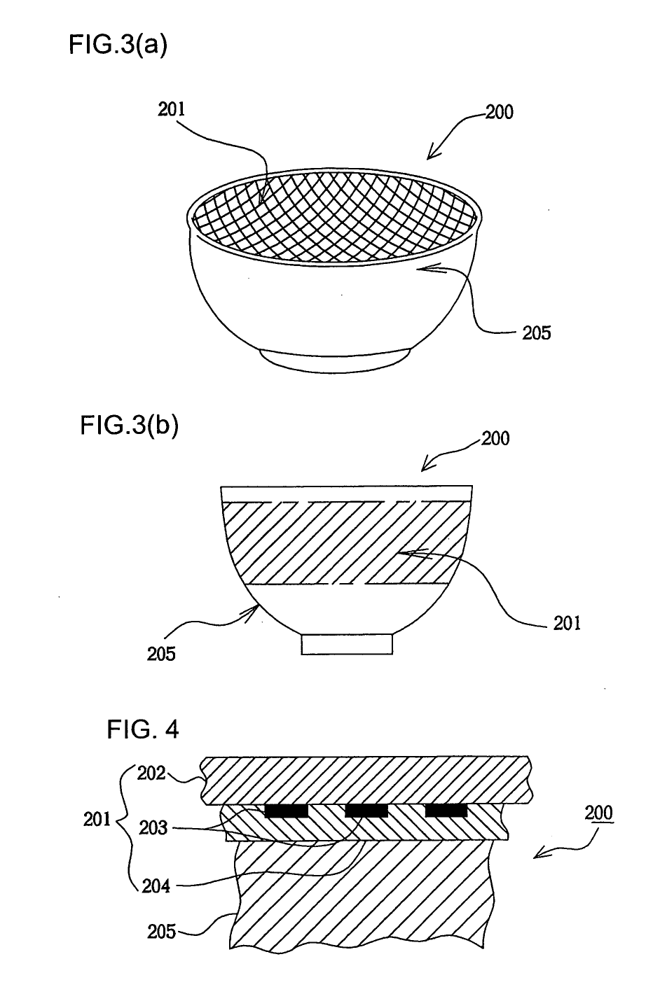

In the present embodiment, manufacture will be made for a molded product 200 as shown in FIG. 3(a) i.e. a dish, bowl, and so on which is made of a resin 205 and has an curved inside surface provided with a printed film 201. It should be noted here, however, that the present invention may also be applied to a formation as shown in FIG. 3(b), in which manufacture is made for a molded product 200 which is made of a resin 205 and has a curved outside surface provided with a printed film 201. Further, the present invention is not limited to these, and sheet formation may be made to a more complicated profile or to a flat profile. Note also, that in the present embodiment, a pre-forming mold and a main mold are both made to form four bowls simultaneously.

The printed film 4 is provided by a film substrate which can be made from many different resins. A design is printed on the substrate. The design can be pictures, figures, characters, symbols, or combination of any of these. If the design will be damaged by the injection molding resin, then as shown in FIG. 4, the printed film 201 may include a protective layer 204 for the design 203, on a surface of a base material 202 facing the design 203. In this particular case, the resin 205 is injected on the side of the protective layer 204, making the side on the base material 202 an upper surface. Alternatively, the side on the protective layer 204 may be the upper surface. In this latter case, the protective layer 204 may be provided by a hard-coat layer of a thermosetting resin such as a urethane resin.

The resin 205 supplied from the injection unit to the main formation apparatus 2 can be a thermoplastic resin such as ABS, PP, PE, PS, PET, PC, acrylic resin and PVC. Any of these materials can be used also for the base material 202. If the resin 205, the base material 202, the design 203 and the protective layer 204 are all made from the same resin or resins of the same family, recycling of plastic products can be facilitated more easily. An example of using the same resin is a case where the base material 202, the design 203 and the protective layer 204 are made from an ABS resin, and the resin 205 is provided by an ABS resin. An example of using resins of the same family is a case where the base material 202, the design 203 and the protective layer 204 are made from an acrylic or styrene resin, and the resin 205 is provided by an ABS resin.

As shown in FIG. 1, the pre-formation apparatus 3 primarily includes a film feeder 62 which supplies and winds the printed film 4, clamp members 68 which clamp the printed film 4 in a pre-forming section F, a heater 70 which heats the printed film 4, a pair of a lower pre-forming mold unit 76 and an upper pre-forming mold unit 82 which work together to perform a pre-forming process, and a punch die unit 91.

In the film feeder 62, the printed film 4 is continuous, and loaded beneath the frame 61 in the form of supply-side film roll 4a and winding-side film roll 4b disposed on the left and the right sides on air clamp shafts 62a, 62b respectively. The air clamp shaft 62a receives an unwinding tension and a back tension from a drive mechanism 63 whereas the air clamp shaft 62b receives a winding tension from the drive mechanism 63. The printed film 4 supplied from the supply-side film roll 4a passes a swing roller 66a and other rollers before it reaches a feed roller 64, then crosses the pre-forming section F horizontally, passes between a rear roller 65a and a nip roller 65b, runs around a swing roller 67a and other rollers before it is wound on the winding-side film roll 4b. The swing roller 66a is on an arm which swings around a swing shaft 66b whereas the swing roller 67a is on an arm which swings around a swing shaft 67b. The printed film 4 is generally horizontal in the pre-forming section F. The rear roller 65a and/or the nip roller 65b is provided with a one-way clutch 72 which prevents the printed film 4 from moving back.

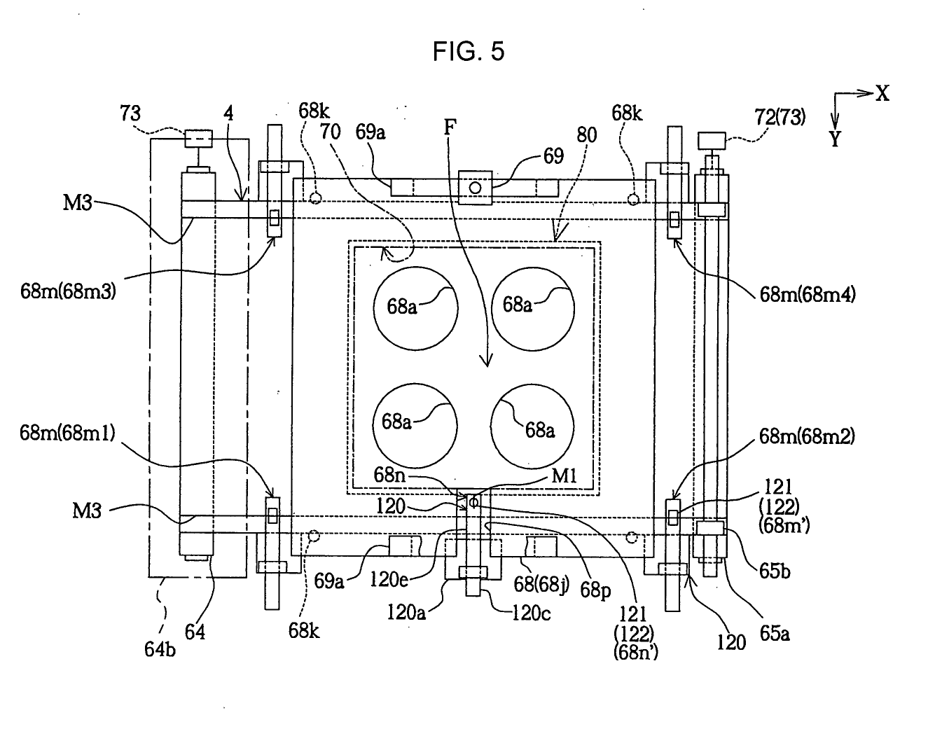

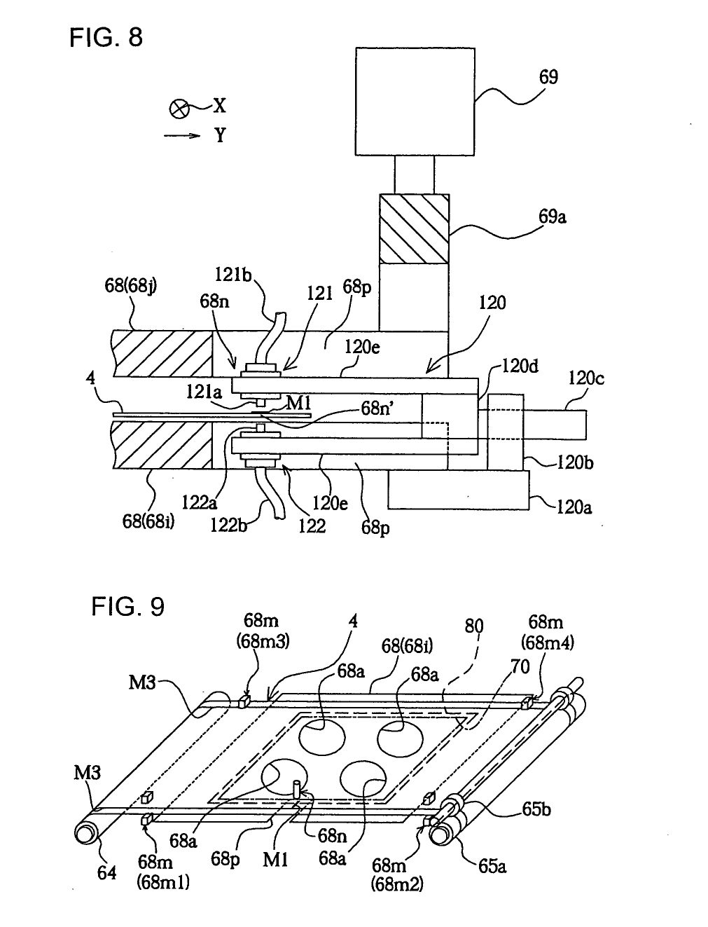

As shown in FIGS. 5 through 8, the clamp members 68 includes an upper clamp member 68j which is movable in vertical directions by a pair of actuators 69, 69 via a pair of fore-and-aft support members 69a, 69a. On the other hand, a lower clamp member 68i is supported on the frame by four supporting rods 68k. Slits 68p, 68p are formed in front portions of the lower clamp member 68i and the upper clamp member 68j, at a center of a right-to-left width, where a flow pitch detecting device 68n is placed which includes a light emitting head 121 and a light receiving head 122.

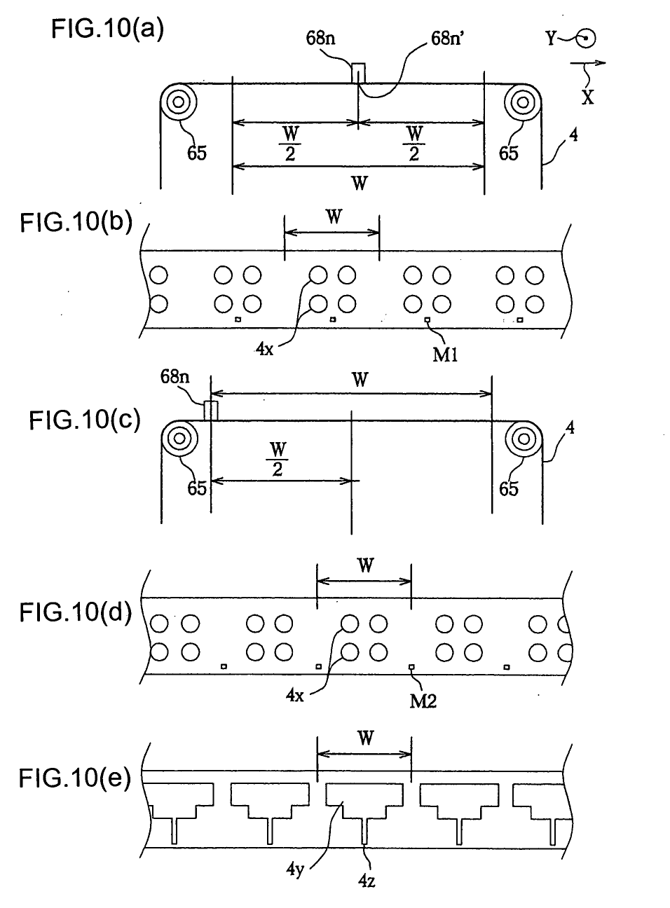

In the present embodiment, as shown in FIGS. 10(a) and (b), the design includes a design 4x and a match mark M1 which is placed at the center point of a single film-feeding pitch W. A common arrangement, however, is as shown in FIG. 10(d): Specifically, a match mark M2 is made on the border of a single pitch W.

In the latter case, assume that the flow pitch detecting device 68n is placed at a position indicated in FIG. 10(c), and assume further that the film has a film elongation rate D per pitch. On these assumptions, the film at the end of a single pitch W will have a film right-end elongation rate of DW. On the contrary, according to the present embodiment, the match mark M1 is at the middle point of a single pitch W, and therefore a maximum value can only be D×W/2=DW/2. Note that the flow pitch detecting device is normally placed a few pitches away from the pre-forming section F, so there will be a larger error due to the film elongation. It should also be noted here that instead of detecting the match mark M1, there may be an arrangement as shown in FIG. 10(e): Specifically a design 4y has a part 4z which serves as a match mark and is detected by a pitch detecting section 68n′.

Thus, the present embodiment enables to minimize positional error of the design 4x caused by film elongation. Specifically, it is understood that the deformation error can be reduced if there are provided the match mark M1 and the pitch detecting section 68n′ of the flow pitch detecting device 68n, and it is most desirable that the match mark M1 and the pitch detecting section 68n′ of the flow pitch detecting device 68n are near or at the center of the pitch W for the sake of error reduction.

Here, more detailed description will be given for the flow pitch detecting device 68n and the construction surrounding it. The slit 68p is formed in a front center portion of the lower clamp member 68i and the upper clamp member 68j, and the flow pitch detecting device 68n is inserted into this slit 68p. The flow pitch detecting device 68n is disposed at a place passed by the match mark M1 which is made for each design 4x. By detecting the match mark M1 with the pitch detecting section 68n′, it becomes possible to place the design 4x at the center of the clamp members 68, i.e. at the center of the mold. The flow pitch detecting device 68n includes a detector support 120 attached to the lower clamp member 68i, and the light emitting head 121 and the light receiving head 122 supported by the detector support 120.

The detector support 120 is attached onto a lower block 120a which bridges the slit 68p in the lower clamp member 68i. The detector support 120 slidably supports a through shaft 120c so that the through shaft is movable to the upright block 120b. The through shaft has a tip having a branching block 120d, from which a parallel pair of upper and lower cantilevers 120e, 120e extend. The upper and the lower cantilevers 120e have free tips, one provided with a light emitting head 121 and the other provided with a light receiving head 122. With this arrangement, a light emitting orifice 121a and a light receiving orifice 122a are facing each other, with a slight clearance between the two, and the pitch detecting section 68n′ is between these two orifices. Thus, detection light from a light source such as a light emitting diode travels through an optical fiber 121b, passes through the printed film 4 and the light receiving orifice 122a, and then through an optical fiber 122b before it reaches a light sensor. Alternatively, a light emitter and a light receiver may be placed directly as the light emitting head 121 and the light receiving head 122 respectively, without using the optical fibers 121b, 122b.

In the present embodiment, the lower clamp member 68i, as well as the feed roller 64 and the rear roller 65a, is not movable in vertical directions relatively to the frame, and the flow pitch detecting device 68n is fixed to the lower clamp member 68i. On the other hand, the upper clamp member 68j moves up and down, and presses down the printed film 4. Therefore, in order to avoid interference between the printed film 4 and the flow pitch detecting device 68n during the movement of the upper clamp member 68j, the level of the pitch detecting section 68n′ of the flow pitch detecting device 68n is made close to the upper surface of the lower clamp member 68i which is the fixed surface of the two mutually opposed surfaces in the clamp members 68. For this reason, the printed film 4 normally stays closer to the upper surface of the lower clamp member 68i than to the lower surface of the upper clamp member 68j. With such a relative positional relationship among the printed film 4, the clamp members 68, and the flow pitch detecting device 68n, it is rare that positioning operation of the printed film 4 is disturbed by the clamping operation of the clamp members 68 on the printed film 4.

Here, reference will be made to FIGS. 5 through 9, and description will cover how the printed film 4 is prevented from meandering. The printed film 4 according to the present invention has its two widthwise margins marked with meandering prevention lines M3, M3, each printed along one of the margins. In order to detect the pair of meandering prevention lines M3, M3, a total of four meandering detectors 68m (68m1-68m4) are provided between the pre-forming section F and each of the feed roller 64 and the rear roller 65a. Each meandering detector 68m has primarily the same construction as described above, including a detector support 120, a light emitting head 121 and a light receiving head 122, with the gap between these heads representing a meandering detection section 68m′. The meandering prevention lines M3, M3 may not be a pair, i.e. a single line may be provided along only on one side of the printed film 4. However, providing two on both sides, with corresponding meandering detectors 68m, will improve meandering correction accuracy.

The feed roller 64 is movable in its axial directions Y which is not indicated in the figures. In accordance with the detection of the meandering prevention lines M3, M3 by the meandering detectors 68m, a meandering prevention device 73 moves the roller accordingly in Y directions. Alternatively, not only the feed roller 64 but also the rear roller 65a and the nip roller 65b may be moved together in the Y directions in the control by the meandering prevention device 73. Another alternative is that the whole structure from the supply-side film roll 4a to the feed roller 64, i.e. the entire film feeder 62 may be made movable for the control by the meandering prevention device 73.

The upper and lower clamp members 68i, 68j generally cover regions of the printed film 4 along a film flowing direction X exposed to the meandering detection sections 68m′. Thus, the meandering prevention lines M3 are generally covered by the clamp members 68i, 68j. Further, the regions of the printed film 4 along the film flowing direction X exposed to the meandering detection sections 68m′ are not faced by the heater 70. Thus, the meandering prevention lines M3 are out of the area exposed to the heater 70. Due to these positional relationships, parts including the meandering prevention lines M3 are not deformed by heat. This enables meandering prevention after the film is punched, reducing an amount of wasted printed film 4 in the flowing direction X.

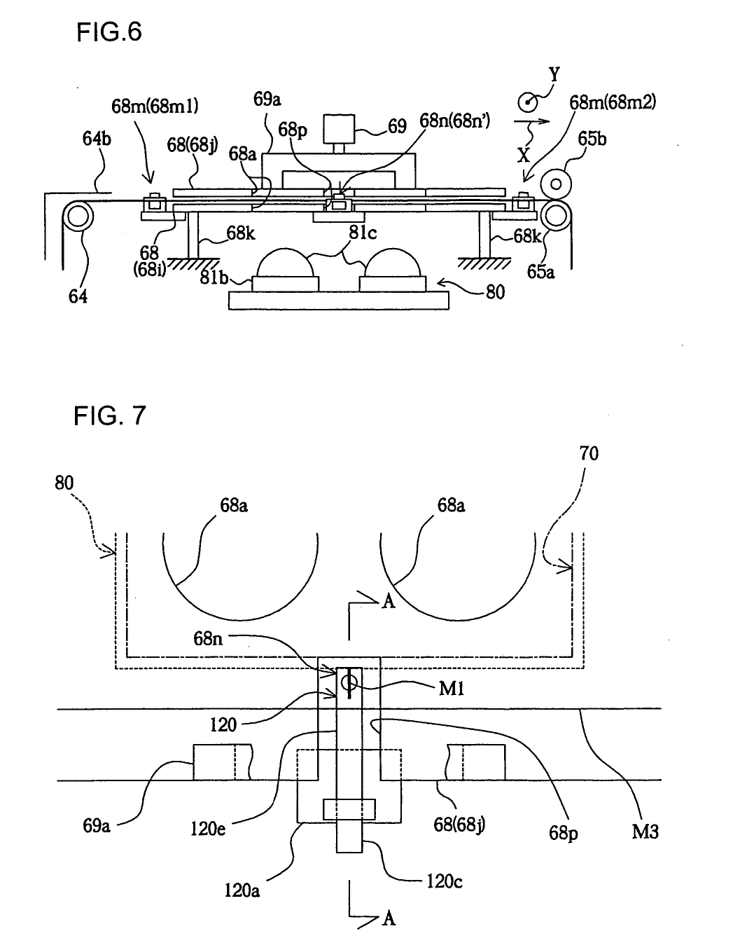

In works, first, the meandering prevention lines M3 on the printed film 4 are detected by the meandering detectors 68m, and the feed roller 64 is finely adjusted in the Y directions by the meandering prevention device 73. While meandering is prevented through these operations, the printed film 4 is supplied. With detection of the match mark M1 by the flow pitch detecting device 68n, the printed film 4 stops at an appropriate position. Then, while the clamp members 68, 68 sandwich the printed film 4, the heater 70 slides from left to right in the direction X as in FIGS. 5 and 6, positioning itself at the center of the upper surface of the upper clamp member 68j. On the side of feed roller 64, above the printed film 4 is a roller guard 64b which prevents the printed film 4 from being heated before being supplied to the clamp members 68, thereby preventing dimensional errors from developing. Then, the printed film 4, which is heated and softened while being supported by the lower clamp member 68i and the upper clamp member 68j, does not develop dimensional errors easily. Combination of this and an upward pressing from below by the lower male molds 81c provides highly accurate formation.

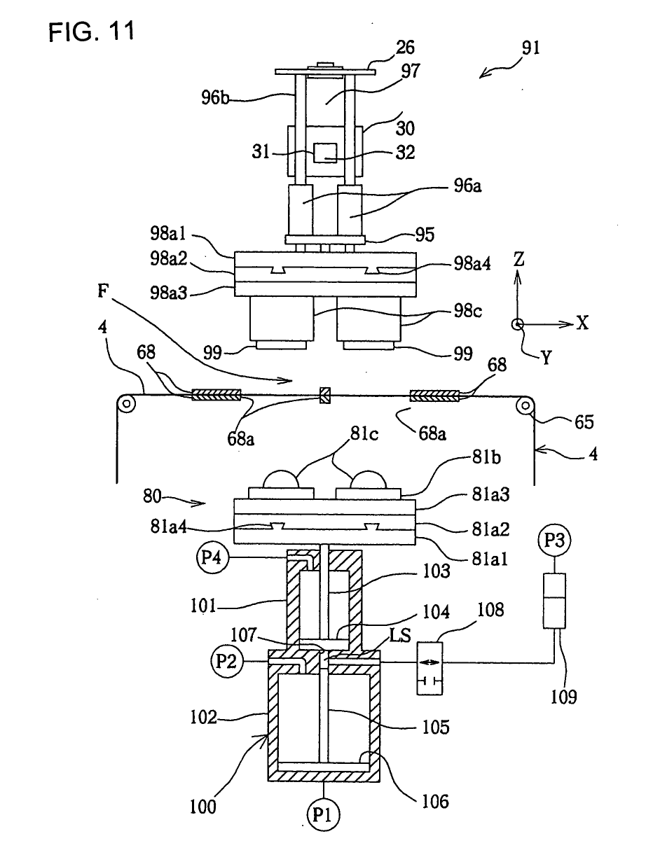

Next, reference will be made to FIGS. 11 through 19 to describe actuators 30, shape of a lower pre-forming mold 80, and an actuator 100.

As shown in FIGS. 11 through 14, a pair of actuators 30, 30 are disposed near a pressure receiving board 26. Each actuator 30 has a rod 31 whose tip has a smoothly curved surface 32 on its lower side. The rod 31 rises on the pressure receiving board 26 when lowered by an actuator 97, and thereby backs up the pressure receiving board 26 and the punch die unit 91.

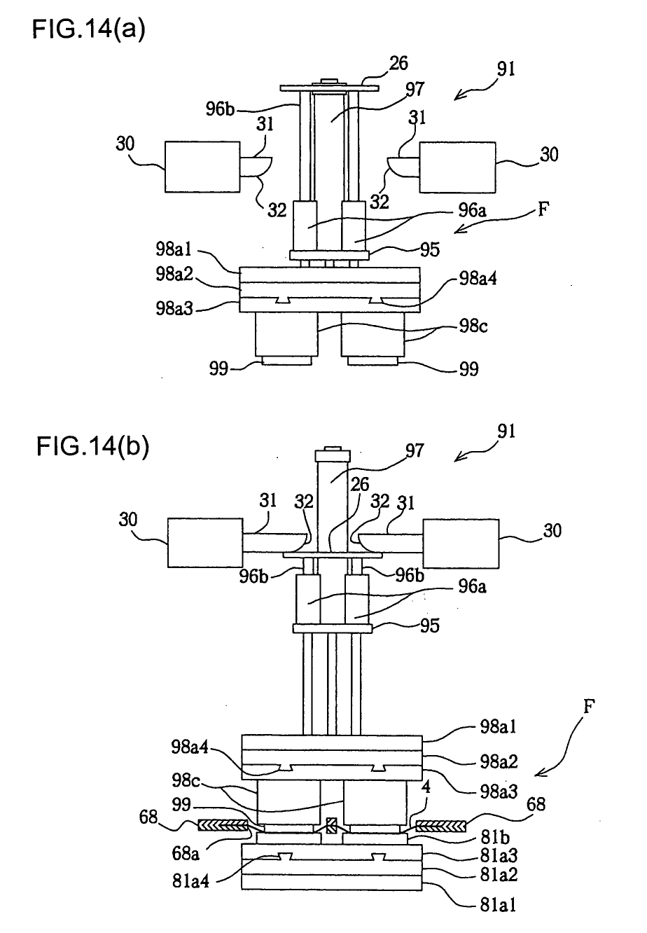

As shown in FIGS. 11 and 14, the lower pre-forming mold 80 has a layered structure, including, sequentially from the bottom, a first through a third lower movable plates 81a1, 81a2, 81a3, a pair of spacers 81b, and then hemispherical lower male molds 81c. A slide mechanism 81a4 is provided between each adjacent pair of the movable plates 81a1 through 81a3, so that the lower male mold 81c can be moved in XY directions with respect to the first lower movable plate 81a1 for fine positional adjustment of the mold.

The punch die unit 91 has a similar construction to that of the lower pre-forming mold 80. Specifically, from top to bottom, a laminate structure includes a first upper movable plate 98a1, a second upper movable plate 98a2, a third upper movable plate 98a3, and a pair of columns 98c. A punch die blade 99 is attached to each column 98c. A slide mechanism 98a4 is provided in each layer, for adjustment in the XY directions as provided by the slide mechanism 81a4. Die punching is made when the clamp members 68 have each of their through holes 68a penetrated by a corresponding one of the punch die blades 99 supported by the column 98c.

FIG. 16 shows an upper pre-forming mold 89, which includes, as are the lower pre-forming mold 80 and the punch die unit 91, a first lower movable plate 88a1, a second lower movable plate 88a2, and the upper pre-forming mold 89 each being adjustable in its relative position in the XY directions by means of a slide mechanism 88a3. The four lower male molds 81c fits into four respective recesses 89a, each formed in one of four disc-like portion protruding out of the lower surface of the upper pre-forming mold 89. Each disc-like portion 89b penetrates a corresponding one of the through holes 68a.

The actuator 100 includes a first cylinder 101 and a second cylinder 102. The first cylinder 101 has a first rod 103 and a first piston 104 whereas the second cylinder 102 has a second rod 105 and a second piston 106. The first cylinder 101 and the second cylinder 102 communicate with each other via a communication channel 107 through which the second rod 105 extends. In the first cylinder 101, a lower side of the first piston 104, an upper side of the second rod 105 and the communication channel 107 define a hydraulic space LS which is filled with oil serving as hydraulic medium.

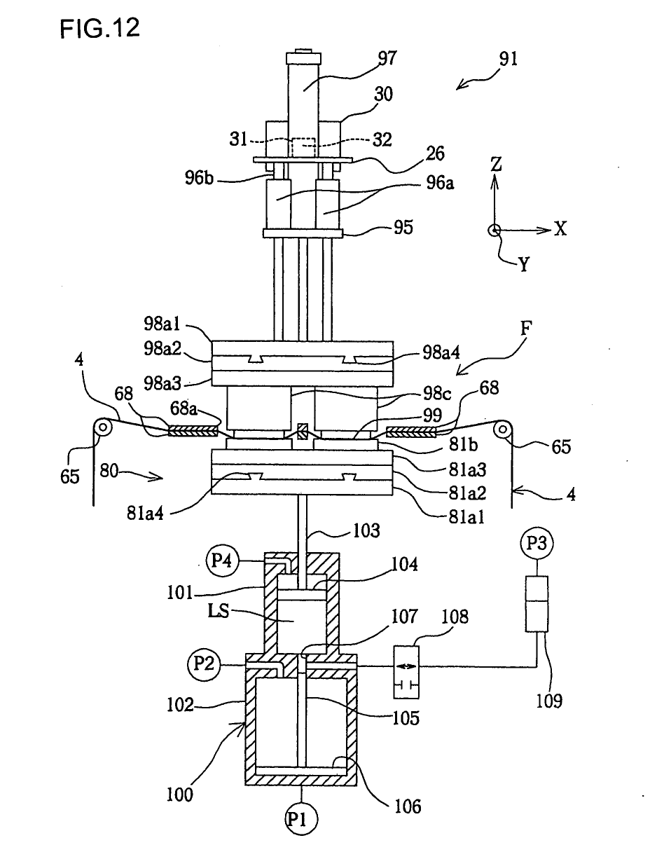

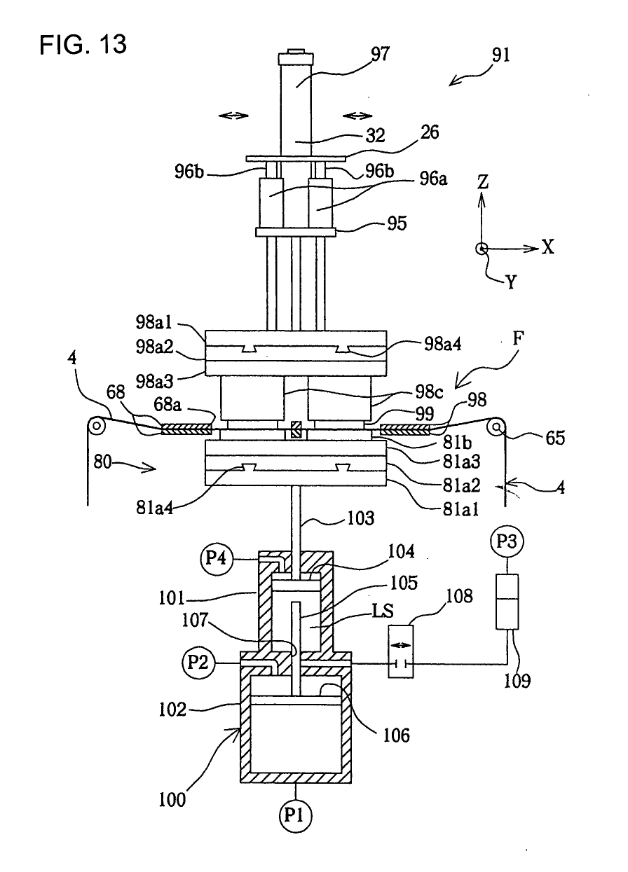

When air is supplied from a third air-intake/discharge port P3, a pneumohydraulic converter 109 converts the air pressure into a hydraulic pressure, which is supplied to the hydraulic space LS via a stop valve 108 and the communication channel 107, and as shown in FIG. 12, presses up the first piston 104 and the first rod 103. Further, when air is supplied from a first air-intake/discharge port P1, air is discharged from a second air-intake/discharge port P2, and as shown in FIG. 13, the second piston 106 and the second rod 105 move up, thereby making the second cylinder 102 functioning as a power booster for the first cylinder 101. The stop valve 108 closes after the air supply from the third air-intake/discharge port P3.

Now, reference will be made to FIG. 2, to describe a relationship between the main formation apparatus 2 and the formed-film conveyer 50 of the pre-formation apparatus 3. The formed-film conveyer 50 includes a turning device 51 which accepts the formation film 5 and turns it by 90 degrees, and a slider 53 which receives the formation film 5 from the turning device 51 and travels to the movable mold 12, on a rail 52. A support plate 51a supported by two support arms 51b is turned by a motor 51c. Four suction discs are provided on the support plate 51a to suck the formation film 5. The slider 53 carries a cross rod 54a which lies crosswise and has tow ends at which two lengthwise rods 54b, 54b are attached to lie lengthwise, so each tip is provided with a sucking disc 54c for holding the formation film 5. The slider 53 is connected with a movable rod of an actuator 54d, and the cross rod 54a is attached to a tip of the movable rod, so the sucking discs are moved in horizontal directions.

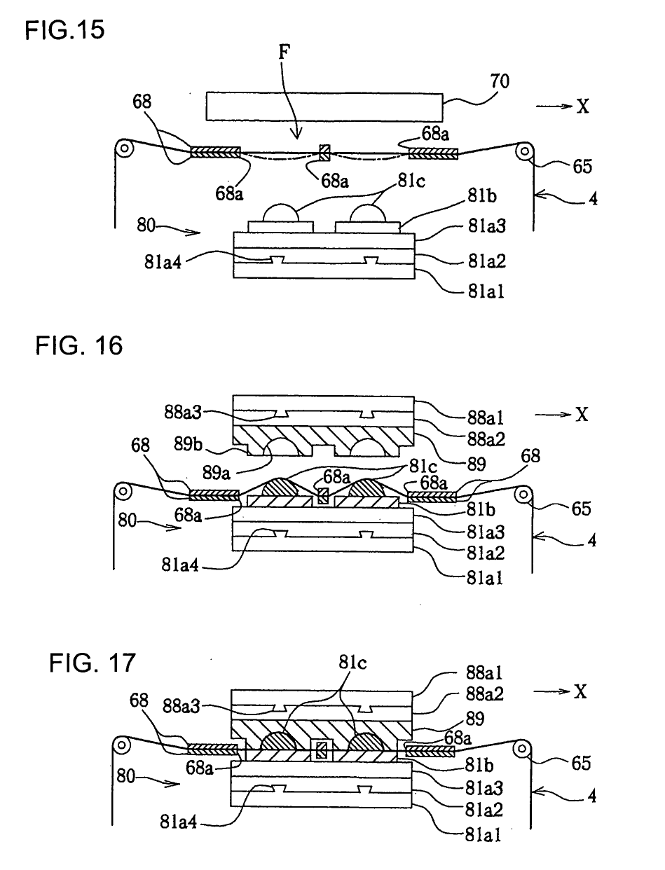

Next, an operation of the pre-formation apparatus according to the present embodiment will be described. First, as shown in FIG. 15, the heater 70 moves from the direction X to the pre-forming section F, on the printed film 4 sandwiched by the clamp members 68, 68, and softens the printed film 4. The softened printed film 4 drapes down as indicated by phantom lines. Next, the heater 70 is moved to the left-hand side, and as shown in FIG. 16, the upper pre-forming mold 89 is moved to the pre-forming section F from the right-hand side, i.e. from the direction X. The lower pre-forming mold 80 is raised to make the lower male molds 81c push up the printed film 4. Thereafter, as shown in FIG. 17, the upper pre-forming mold 89 is lowered to sandwich and thereby to shape the softened printed film 4 between the lower male molds 81c and the recesses 89a. During these steps, the lower pre-forming mold 80 is raised solely by the first cylinder 101.

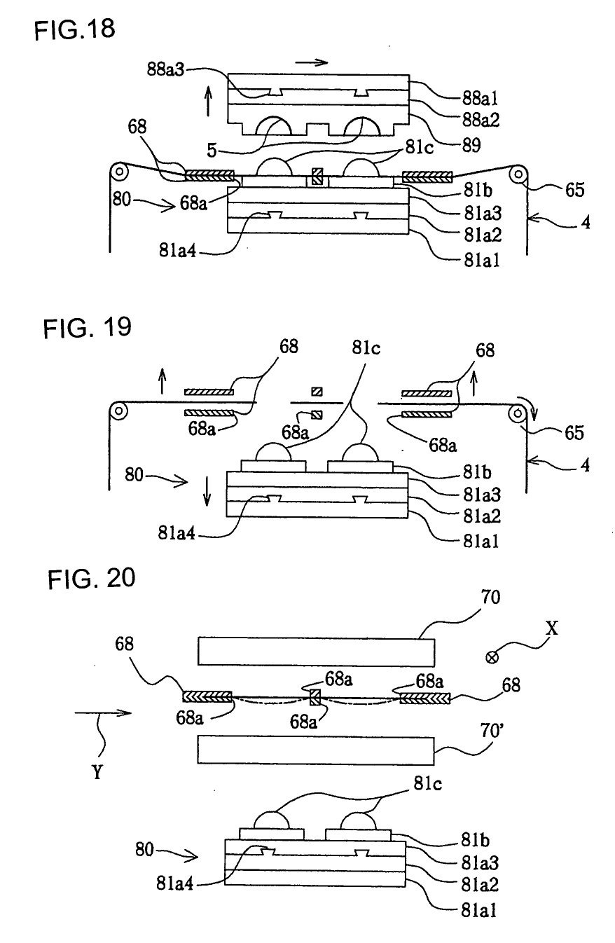

Next, the punch die unit 91 in FIG. 12 moves from left to the pre-forming section F, and lowers the punch die blade 99. Further, as shown in FIGS. 12 and 14(b), the rod 31 extends to backup the pressure receiving board 26. Under this state, as shown in FIG. 13, pressurized air is supplied from the first air-intake/discharge port P1 to press the punch die blade 99 onto the upper surface of the spacer 81b, thereby cutting the formed printed film 4. Thereafter, as shown in FIG. 18, the formation film 5 punched by the upper pre-forming mold 89 is moved by the upper pre-forming mold 89, and then as shown in FIG. 19, the lower pre-forming mold 80 is lowered, the clamp members 68, 68 are moved away from the printed film 4, and the printed film 4 after being punched is wound up by the film feeder 62. Conventionally, punching is not performed in a pre-forming process, and the pre-forming process left wrinkles in unnecessary part of the film, making it difficult to windup the film after the pre-forming process. However, the present invention has enabled smooth winding after the pre-forming process by introducing a punching step performed by the punch die unit 91. After the winding, the punched formation film 5 is moved by the formed-film conveyer 5 for a main formation process. Hence, no step in the main formation apparatus 2 interferes with the steps in the pre-formation apparatus 3, and the in-mold or insert molding can be as quick as conventionally.

Next, FIG. 20 shows a second embodiment, which is provided with another of the heater 70 or a heater 70′ beneath the printed film 4 in the pre-forming section F, for heating the printed film 4 from below. As described earlier, the heater 70 moves in the direction X. On the other hand, the heater 70′ moves in Y direction, from behind to the front of the apparatus. If, for example, the printed film 4 has a laminated structure which has an upper layer and a lower layer made of different materials, it is sometimes necessary for the two surfaces to be heated individually from each other. For this reason, the heater 70 and the heater 70′ are controllable independently from each other.

Finally, still other embodiments of the present invention will be mentioned.

Specifically, in the above-mentioned embodiments, the main formation apparatus 2 takes the part of injection molding. However, a main formation apparatus 2 to be used with a pre-formation apparatus 3 according to the present invention may use whatever method of formation as long as the resin is thermoplastic. For instance, the method may be blow molding. The molded product may be of whatever category, the shape may be flat or curved by deep-drawing, and the design may be printed on both of the inner and the outer surfaces.

In the above embodiments, the printed film 4 is provided in the form of a roll. However, the printed film 4 may be a cut sheet of film. In this case, the film feeder 62 can be replaced by the formed-film conveyer 50 or a similar apparatus.

In the above embodiments, the actuator 30 is provided in the upper pre-forming mold unit 82 whereas on the lower side, the lower pre-forming mold 80 is provided with the actuator 100 which is a two-step pressurizer. Theoretically, the actuator 30 may be on the lower pre-forming mold 80 and the actuator 100 may be on the upper pre-forming mold unit 82. A disadvantage, however, is that the actuator 100 is a larger apparatus, so for this reason, the actuator 100 should preferably be on the lower pre-forming mold 80.

In the above embodiments, the lower mold is male and the upper mold is female. Alternatively, the upper mold may be male, which may be lowered to contact the printed film, and then the lower female mold may be mated for formation by vacuum. Note, however, that deforming the film by contact will be smoother in the former case than in this latter arrangement.

It should be noted here that codes in the claims are only for convenience in making reference to the drawings. These codes do not limit the present invention to the constructions depicted in the attached drawings. Any numeric values used to describe conditions such as temperature are examples, and the conditions are not limited to those specific values given in the embodiments.

### INDUSTRIAL APPLICABILITY

The present invention is applicable to insert molding in which a sheet carrying a design is integrally fitted onto the surface of a product, or to in-mold formation in which a design on a sheet is printed onto the surface of a product, and the present invention can be used as a pre-formation apparatus, a pre-formation method, a main formation method and a printed film for these methods.

1. A pre-formation apparatus comprising: a film feeder (62) for supplying a printed film (4) to a pre-forming section (F) where a pre-formation is performed; an upper and a lower clamp members (68i, 68j) for sandwiching the printed film in the pre-forming section (F), and having a through hole (68a); a heater (70) movable to and away from the pre-forming section (F) for heating to plasticize the printed film sandwiched by the upper and lower clamp members (68i, 68j) in the pre-forming section before the pre-formation; pre-forming molds (80, 89) movable to and away from the pre-forming section for pre-forming the printed film (4) via the through hole (68a); and a film die punch (91) for punching the printed film (4) after the pre-formation; wherein the pre-forming molds (80, 89) includes a male mold (81c) for contacting the plasticized printed film and a female mold (89a) to mate with the male mold for a vacuum formation, the pre-formation apparatus further comprising: a pitch detecting section (68n′) facing the pre-forming section (F), within a pre-formation pitch (W) of the printed film (4) in a film flow direction (X) for detection of a film mark (M1); meandering detection sections (68m′) between the pre-forming section (F) and the pair of rollers (64, 65a) which support the printed film (4) for detecting a meandering prevention line printed on the printed film; and a meandering prevention device controlled by this second detection section as part of the film feeder; the upper and lower clamp members (68i, 68j) generally covering a region of the printed film (4) exposed to the meandering detection sections 68m′ along the film flowing direction (X).

2. The pre-formation apparatus according to claim 1, wherein the pitch detecting section (68n′) for detecting the film mark (M1) is displaced in a direction perpendicular to the film flow direction and independent from the pre-forming molds (80, 89).

3. The pre-formation apparatus according to claim 1, wherein the pitch detecting section (68n′) is disposed at a center of the width of pitch (W).

4. The pre-formation apparatus according to claim 1, wherein the pitch detecting section (68n′) has at least its vertical position fixed with respect to a pair of rollers (64, 65a) which support the printed film (4) in the pre-forming section (F).

5. The pre-formation apparatus according to claim 1, wherein the lower clamp member (68i) has at least it vertical position fixed with respect to a pair of rollers (64, 65a) which support the printed film (4) in the pre-forming section (F), the pitch detecting section (68n′) being virtually fixed to the lower clamp member (68i).

6. The pre-formation apparatus according to claim 5, wherein the upper clamp member (68j) is formed with a slit (68p) for housing the pitch detecting section (68n′).

7. The pre-formation apparatus according to claim 1, wherein the meandering detection sections 68m′ along a film flowing direction (X).

8. The pre-formation apparatus according to claim 1, wherein the meandering detection sections (68m′) is provided on two sides of the printed film (4) with respect to a film flowing direction (X).

9. The pre-formation method using the pre-formation apparatus according to claims 1 through 8, the method comprising: a step of causing the film feeder (62) to supply the printed film (4) to the pre-forming section (F) where a pre-formation is performed; a step of stopping the film supply through detection of the film mark (M1) by the pitch detecting section (68n′) within the pitch (W) in the film flowing direction (X) of the printed film (4); a step of causing the upper and a lower clamp members (68i, 68j) to sandwich a margin around a formation region of the printed film (4); a step of moving a heater (70) close to the pre-forming section (F) and heating to plasticize the printed film; a step of performing the pre-formation using the pre-forming molds (80, 89); and a step of punching the pre-formed film for making a formation film (5) for insertion into the main mold.

10. A main formation method using the pre-formation apparatus according to one of claims 1 through 8, the method comprising: a step of causing the film feeder (62) to supplying a printed film (4) to a pre-forming section (F) for a pre-formation; a step of stopping the film supply through detection of the film mark (M1) by the pitch detecting section (68n′) within the pitch (W) in the film flowing direction (X) of the printed film (4); a step of causing the upper and a lower clamp members (68i, 68j) to sandwich a margin around a formation region of the printed film (4); a step of moving a heater (70) close to the pre-forming section (F) and heating to plasticize the printed film; a step of performing the pre-formation using the pre-forming molds (80, 89); and a step of punching the pre-formed film for making a formation film (5).

11. A printed film for use the pre-formation apparatus according to one of claims 1 through 8, provided with: a film mark (M1) at a center of a pitch (W) in a film flow direction (X) and a meandering prevention line (M3).

12. (canceled)
